(19) United States
(12) Patent Application Publication
(10) Pub. No.: US 2024/0052776 A1
(43) Pub. Date: Feb. 15, 2024

(54) ROTARY PISTON ENGINE

(71) Applicant: Winkelmann Wankel GmbH, Frechen (DE)

(72) Inventor: Wolfgang Baier, Obbach (DE)

(21) Appl. No.: 18/448,123

(22) Filed: Aug. 10, 2023

(30) Foreign Application Priority Data
Aug. 12, 2022 (DE) 10 2022 120 394.8

(51) Int. Cl. F02B 55/10

(52) U.S. Cl. CPC F02B 55/10

(57) ABSTRACT

A rotary piston engine having a casing and a rotary piston rotating in the casing, the casing comprising a central casing part with a casing wall enclosing the rotating rotary piston, the central casing part being covered by a first cover part and a second cover part on opposite sides to form a closed casing interior, and the central casing part comprising an inner cooling channel, the first cover part comprises a first outer cooling channel and the second cover part comprises a second outer cooling channel, into which a cooling medium flows via an inlet, which cooling medium flows out of the same via an outlet, and wherein the inlet comprises a metering element configured to supply a varying amount of coolant to the inner cooling channel and respectively to the first outer cooling channel and the second outer cooling channel.

### CROSS-REFERENCE TO RELATED APPLICATIONS

This patent application claims priority to German utility patent application number 10 2022 120 394.8 filed Aug. 12, 2022, and titled “rotary piston engine”. The subject matter of patent application number 10 2022 120 394.8 is hereby incorporated by reference in its entirety.

### STATEMENT REGARDING FEDERALLY SPONSORED RESEARCH OR DEVELOPMENT

Not Applicable.

### INCORPORATION BY REFERENCE OF MATERIAL SUBMITTED ON A COMPACT DISC

Not Applicable.

### FIELD OF THE INVENTION

The present invention relates to the technical field of rotary piston engines operating according to the four-stroke principle of internal combustion engines, such as Wankel rotary piston engines.

### BACKGROUND

In a rotary piston engine, a triangular rotary piston rotates in a casing. The (arcuate-triangular) rotary piston consists of three flattened circular arcs and constantly contacts a double-arched casing wall while rotating. The casing includes an inlet and an outlet and one or more spark plugs, the inlet, the outlet and the spark plugs being arranged separately in such a way that the rotary piston in a predetermined position separates the respective chamber volumes with inlet, outlet and spark plugs.

Since the inlet and outlet are physically separated from the combustion chamber, the Wankel engine is very suitable for being driven by hydrogen. When hydrogen is used as a fuel, even the disadvantage of incomplete combustion due to the unfavorably shaped combustion chamber is not critical because the uncombusted fuel discharged is harmless to the environment. In the course of the conversion of drive systems in motor vehicles away from fossil fuels, the use of hydrogen as a fuel is increasingly attracting interest.

From the point of view of thermal stress, it is problematic with rotary piston engines that the power stroke always takes place at the same point, which is why a steady-state temperature distribution with spatially and temporally steady-state hot and cold zones is created. The rotary piston engine exhibits the highest temperatures in the casing area of the spark plugs towards the outlet and the lowest temperatures in the area located behind the inlet towards the spark plugs. In the case of the rotary piston engine, no cooling mixture ever flows past in the area between the spark plug and the outlet, unlike in the case of the reciprocating piston engine where the combustion chamber is cooled by the intake mixture during the intake stroke. This leads to a very uneven thermal load exerted on the casing of the rotary piston engine. A particularly high load results from the fact that ignition takes place with every rotation, which results in a high ignition sequence with a correspondingly high thermal load compared to the reciprocating four-stroke engine.

To dissipate the heat, a radial cooling water guide system is known, whereby the casing is provided in sections (in the hot arc) against the direction of rotation of the rotary piston with a cooling channel through which a coolant flows. It is also known to cool the side parts of the casing with a coolant.

### SUMMARY

It is the object of the present invention to minimize the thermal load and, in particular, to provide the cooling medium appropriately to ensure efficient heat dissipation.

The invention encompasses a rotary piston engine having a casing and a rotary piston rotating within the casing. The casing includes a central casing part having a casing wall enclosing the rotating rotary piston. The central casing part is covered by a first cover part and a second cover part on opposite sides to form a closed casing interior. The central casing part includes an inner cooling channel, the first cover part includes a first outer cooling channel, and the second cover part includes a second outer cooling channel, into which a cooling medium flows via an inlet, which cooling medium flows out of the same via an outlet. The inlet includes a metering element configured to supply a varying amount of coolant to the inner cooling channel and respectively to the first outer cooling channel and the second outer cooling channel. By providing a metering element at the inlet for the cooling medium that specifically supplies the cooling medium to the inner cooling channel and the two outer cooling channels, efficient cooling can be realized that takes into account, for example, that different amounts of heat are generated in the central casing and the two cover parts during operation of the rotary engine.

### BRIEF DESCRIPTION OF THE DRAWINGS

In the following, the invention is further explained below with reference to the examples shown in the drawings, wherein:

FIG. 1 shows a partial sectional view of a rotary piston engine with casing comprising a central casing part and first and second cover parts with a metering element according to an exemplary embodiment of the invention;

FIG. 2 shows a further sectional view of a central casing part of a rotary piston engine of FIG. 1; and

FIG. 3 shows a sectional view of a casing cover part from a rotary piston engine of FIG. 1.

### DETAILED DESCRIPTION

In one advantageous technical aspect, the metering element is configured such that the amount of cooling medium supplied to the inner cooling channel, the first outer cooling channel and the second outer cooling channel is selected such that the temperature difference of the cooling medium from the cooling channels at the outlet is less than 5%. The metering element may have a size and shape to meter the cooling medium appropriately so that it does not fall below a specified minimum temperature difference.

Preferably, the metering element is designed such that the amount of cooling medium supplied to the inner cooling channel and the amount of cooling medium supplied to the first outer cooling channel and the second outer cooling channel has a deviation in the range of less than 5%.

Advantageously, the amount of cooling medium supplied to the first outer cooling channel and the second outer cooling channel is identical.

Particularly preferably, the amount of cooling medium supplied to the inner cooling channel is in the range of 65% to 75% (5% to 15%) of the amount of cooling medium supplied. In practice, these volume flow rates have resulted in good dissipation of the generated heat in all casing parts.

According to an advantageous aspect, the metering element comprises a metering sleeve. The metering sleeve is, for example, a metal sleeve onto which a supply hose for the cooling medium can be fitted and which has openings leading into the respective cooling channels, wherein the openings can be dimensioned in cross-section in conformity with the desired flow rate.

Particularly advantageously, the metering sleeve is of such a size and shape as to be insertable into the inlet.

Advantageously, the metering sleeve comprises a first opening for supplying the cooling medium to the first outer cooling channel, a second opening for supplying the cooling medium to the inner cooling channel, and a third opening for supplying the cooling medium to the second outer cooling channel. The openings can be different in number and size for each cooling channel.

Advantageously, the metering sleeve comprises two second openings for supplying the cooling medium to the inner cooling channel.

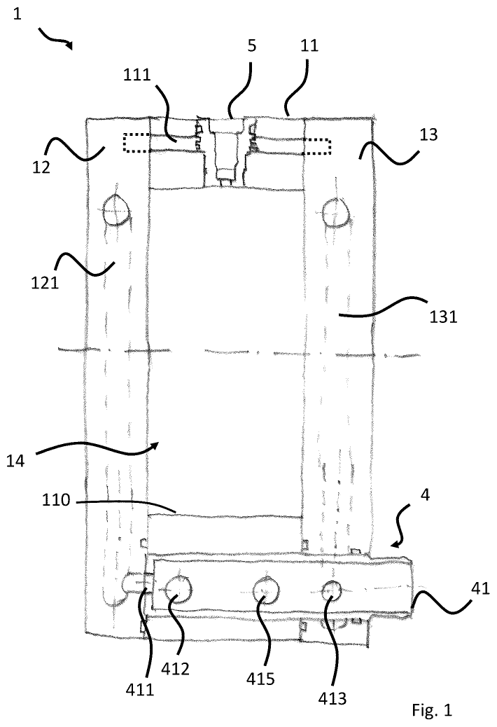

FIG. 1 is a partially vertical sectional view (without a rotating rotary piston) of a rotary piston engine with a casing 1 comprising a central casing part 11 and a first cover part 12 and a second cover part 13, according to an exemplary embodiment of the invention.

The illustrated casing 1 has a central casing part 11 with a casing wall 110 enclosing the rotating rotary piston. The central casing part 11 is closed on the left side by a first cover part 12 (as a side part). The central casing part 11 is covered on the right side by a second cover part 13 (as a side part). In this way, a closed casing interior 14 is created through which the rotary piston runs in accordance with known Wankel engines.

The central casing part 11 has an inner cooling channel 111 (which has a rib in the center) shown in the upper portion. The dashed sections are lateral widenings in the area of the spark plug and the outlet channel to keep the cross-section constant, in areas where the spark plugs pass through.

The first cover part 12 has a first outer cooling channel 121. The second cover part 13 has a second outer cooling channel 131.

In the lower area, a metering element 4 in the form of a metering sleeve 41 is shown. A cooling medium flows through the metering sleeve 41 into the cooling channels via an inlet 2, in order to flow out of the same again via an outlet 3 and be lead to a cooler, for example.

The metering sleeve 41 is formed with correspondingly shaped openings in such a way as to supply a varying amount of coolant to the inner cooling channel 111 and respectively to the first outer cooling channel 121 and the second outer cooling channel 131.

The metering sleeve 41 is sized and shaped to be insertable into the inlet 2.

The metering sleeve 41 has a first opening 411 for supplying the cooling medium to the first outer cooling channel 121, a second opening 412, 415 for supplying the cooling medium to the inner cooling channel 111 and a third opening 413 for supplying the cooling medium to the second outer cooling channel 131.

The metering sleeve 41 has two second openings 412, 415 for supplying the cooling medium to the inner cooling channel 111.

The metering element 4 is dimensioned in terms of shape and size (of the metering holes 411, 412, 415, 413) such that the amount of cooling medium supplied to the inner cooling channel 111, the first outer cooling channel 121 and the second outer cooling channel 131 is selected such that the temperature difference of the cooling medium from the cooling channels at the outlet 3 measured via a sensor element (not shown) is less than 5%, in particular in the range of 1% to 3%.

The metering element 4 is dimensioned in terms of shape and size such that the amount of cooling medium supplied to the inner cooling channel 111 and the amount of cooling medium supplied to the first outer cooling channel 121 and the second outer cooling channel 131 has a deviation in the range of less than 5%, in particular in the range of 1% to 3%.

Advantageously, the amount of cooling medium supplied to the first outer cooling channel 121 and the second outer cooling channel 131 is identical and different from the amount present in the inner cooling channel 111.

The amount of cooling medium supplied to the inner cooling channel 111 may be in the range of 65% to 75% (5% to 15%) of the amount of cooling medium supplied.

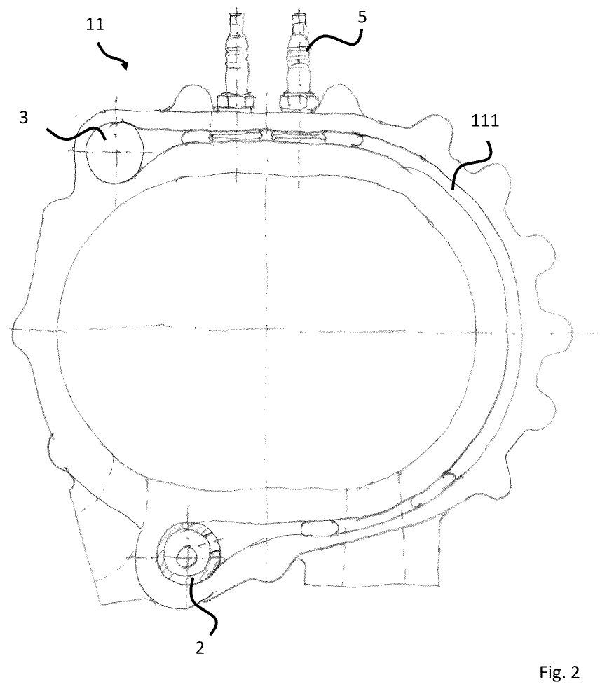

FIG. 2 shows another sectional view of a central casing part 11 from a rotary piston engine of FIG. 1.

The inner cooling channel 111 runs over a part of the casing that is exposed to increased thermal stress. The cooling medium flows counterclockwise and against the direction of rotation of the rotary piston from the inlet 2 at the bottom to the outlet 3 at the top.

In the area of the spark plugs 5 and the outlet channel, the inner cooling channel 111 is widened outward so that the cross-section remains constant.

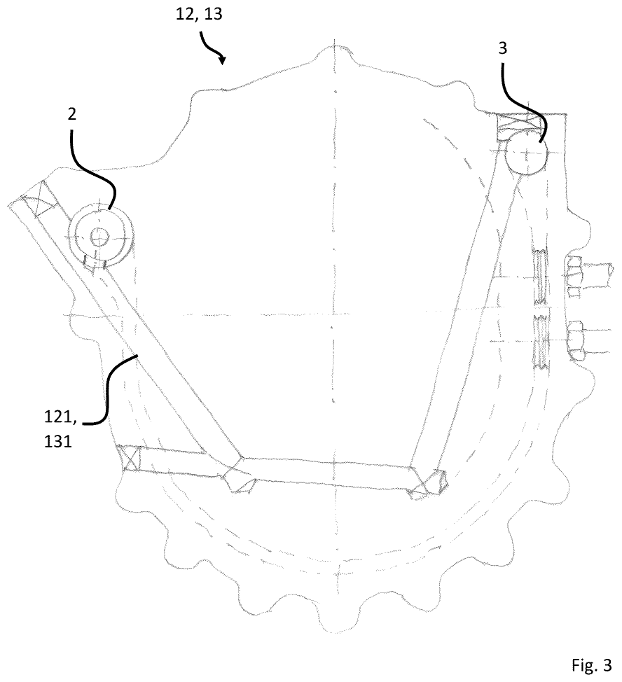

FIG. 3 shows a sectional view of a casing cover part 12, 13 from a rotary piston engine of FIG. 1, which can be connected to the central casing part of FIG. 2. In this illustration, the first cover part 12 with the first outer cooling channel 121 and the second cover part 13 with the second outer cooling channel 131 can be explained because they are mirror images of each other.

The first outer cooling channel 121 and the second outer cooling channel 131 consist of three straight bores, which result in a downwardly curved cooling channel that covers the hot arc of the casing. The straight bores are a particularly convenient solution for manufacturing.

1. Rotary piston engine having a casing and a rotary piston rotating in the casing, the casing comprising a central casing part with a casing wall enclosing the rotating rotary piston, wherein the central casing part is covered by a first cover part and a second cover part on opposite sides to form a closed casing interior, and wherein the central casing part comprises an inner cooling channel, the first cover part comprises a first outer cooling channel and the second cover part comprises a second outer cooling channel, into which a cooling medium flows via an inlet, which cooling medium flows out of the same via an outlet, and wherein the inlet comprises a metering element configured to supply a varying amount of coolant to the inner cooling channel and respectively to the first outer cooling channel and the second outer cooling channel.

2. Rotary piston engine according to claim 1, wherein the metering element is designed in such a way that the amount of cooling medium supplied to the inner cooling channel, the first outer cooling channel and the second outer cooling channel is selected in such a way that the temperature difference of the cooling medium from the cooling channels at the outlet is less than 5%.

3. Rotary piston engine according to claim 1, wherein the metering element is designed in such a way that the amount of cooling medium supplied to the inner cooling channel and the amount of cooling medium supplied to the first outer cooling channel and the second outer cooling channel has a deviation in the range of less than 5%.

4. Rotary piston engine according to claim 1, wherein the amount of cooling medium supplied to the first outer cooling channel and the second outer cooling channel is identical.

5. Rotary piston engine according to claim 1, wherein the amount of cooling medium supplied to the inner cooling channel is in the range of 65% to 75% of the amount of cooling medium supplied, in particular in the range of 5% to 15% of the amount of cooling medium supplied.

6. Rotary piston engine according to claim 1, wherein the metering element comprises a metering sleeve.

7. Rotary piston engine according to claim 6, wherein the metering sleeve is designed to be insertable into the inlet.

8. Rotary piston engine according to claim 6, wherein the metering sleeve comprises a first opening for supplying the cooling medium to the first outer cooling channel, a second opening for supplying the cooling medium to the inner cooling channel and a third opening for supplying the cooling medium to the second outer cooling channel.

9. Rotary piston engine according to claim 1, wherein the metering sleeve comprises two second openings for supplying the cooling medium to the inner cooling channel.
